(19) United States
(12) Patent Application Publication
(10) Pub. No.: US 2016/0321456 A1
(43) Pub. Date: Nov. 3, 2016

(54) SYSTEMS, METHODS AND ASSOCIATED PROGRAM PRODUCTS TO MINIMIZE, RETRIEVE, SECURE AND SELECTIVELY DISTRIBUTE PERSONAL DATA

(71) Applicant: Joseph Schuman, New York, NY (US)

(72) Inventor: Joseph Schuman, New York, NY (US)

(21) Appl. No.: 15/105,842

(22) PCT Filed: Dec. 18, 2014
(86) PCT No.: PCT/US14/71134

§ 371 Date: Jun. 17, 2016

Related U.S. Application Data
(60) Provisional application No. 61/917,726, filed on Dec. 18, 2013.
(60) Provisional application No. 61/917,713, filed on Dec. 18, 2013.

(51) Int. Cl. G06F 21/60; G06F 21/62; G06F 17/30

(52) U.S. Cl. CPC G06F 21/602; G06F 17/30312; G06F 21/6218

(57) ABSTRACT

A data management system is disclosed, and comprises a hardware interface, a data retrieval module, an encryption module, and an encrypted database. The hardware interface electronically couples with one or more computer systems. The data retrieval module is configured to access and retrieve data on a third-party electronic network. The encryption module applies encryption to the data such that an at least partially-anonymized subset of the data is available in response to a request for data. The encrypted database stores the data and the at least partially-anonymized subset of the data.

### CROSS-REFERENCE TO RELATED APPLICATIONS

The present application claims the benefit of and priority to U.S. Provisional Patent Application No. 61/917,726, filed on Dec. 18, 2013, and U.S. Provisional Patent Application No. 61/917,713, filed on Dec. 18, 2013, the entire contents of each of which are incorporated by reference herein.

### FIELD

The present invention generally relates to systems, methods, and associated program products for minimizing, retrieving, securing, and selectively distributing data associated with personal information corresponding to a user.

### BACKGROUND

With the ever-expanding scope of the interne and other third-party electronic networks (for example, social media networks and product purchase websites) and electronic devices, a wealth of data associated with users and their actions on these electronic networks and electronic devices is accumulated over time. Such information can include, for example, bibliographic information, past user action data, third-party affiliation data, and consumer preference data. Such information is typically widely distributed across multiple electronic networks and electronic devices.

### SUMMARY

It is an object of the present invention to provide a centralized source for data associated with personal information corresponding to a user that is accessible in a manner determined by the user. Accordingly, it is an object of the present invention to provide systems, methods, and associated program products for minimizing, retrieving, securing, and selectively distributing data associated with personal information corresponding to a user.

In an exemplary embodiment, a data management system is disclosed, and comprises a hardware interface, a data retrieval module, an encryption module, and an encrypted database. The hardware interface electronically couples with one or more computer systems. The data retrieval module is configured to access and retrieve data on a third-party electronic network. The encryption module applies encryption to the data such that an at least partially-anonymized subset of the data is available in response to a request for data. The encrypted database stores the data and the at least partially-anonymized subset of the data.

In embodiments, the data is associated with personal information corresponding to a user.

In embodiments, the data management system further comprises a local data module configured to access data on an electronic device.

In embodiments, the data management system further comprises a privacy module configured to access privacy settings on the third-party electronic network.

In embodiments, the privacy module is configured to change privacy settings on the third-party electronic network.

In embodiments, the data management system further comprises a data deletion module configured to access data on an electronic device.

In embodiments, the data deletion module is configured to delete data on the electronic device.

In embodiments, the data management system further comprises a data filter module configured to filter a stream of data transmitted through the data management system.

In embodiments, the data management system further comprises an outbound data encryption module configured to encrypt a set of data transmitted from the data management system to the third-party electronic network.

In embodiments, the data management system further comprises a data leveraging module configured to receive a request for data from the third-party electronic network.

In embodiments, the data management system further comprises a data access module configured to retrieve the at least partially-anonymized subset of the data from the encrypted database in response to the request for data.

In embodiments, the request for data is a Boolean-type request.

In embodiments, the data leveraging module is configured to transmit the at least partially-anonymized subset of the data in response to the request for data.

In embodiments, encryption applied to the data by the encryption module comprises at least one of aggregating and compiling the data.

In an exemplary embodiment, a method is disclosed, and comprises: (a) retrieving, by a data management system interfaced with a computer system, data from an electronic network; (b) encrypting, by an encryption module of the data management system, the data retrieved from the electronic network; (c) providing, by the encryption module of the data management system, an at least partially-anonymized subset of the data retrieved from the electronic network that is available separately from the data; and (d) storing, by the data management system, the data and the at least partially-anonymized subset of the data on an encrypted database of the data management system.

In embodiments, the data is associated with personal information corresponding to a user.

In embodiments, the step of encrypting comprises aggregating the data.

In an exemplary embodiment, a method is disclosed, and comprises: (a) accessing, by a data management system interfaced with a computer system, an electronic network; (b) determining, by a privacy module of the data management system, a method of accessing a privacy setting associated with the electronic network; (c) accessing, by the privacy module of the data management system, the privacy setting associated with the electronic network; and (d) altering, by the privacy module of the data management system, the privacy setting associated with the electronic network.

In embodiments, the step of altering the privacy setting associated with the electronic network comprises transmitting a data worm to the electronic network.

In embodiments, the step of determining a method of accessing a privacy setting associated with the electronic network comprises selecting a method from a privacy settings module associated with the privacy module.

### BRIEF DESCRIPTION OF THE DRAWINGS

Various exemplary embodiments of this invention will be described in detail, with reference to the following figures, wherein:

FIG. 1 is a perspective view of a data management system according to an exemplary embodiment of the present invention;

FIG. 2 is a schematic diagram of the data management system of FIG. 1;

FIG. 3 is a schematic flow diagram illustrating data retrieval from a third-party electronic network by the data management system of FIG. 1;

FIG. 4 is a schematic flow diagram illustrating data retrieval from an electronic device by the data management system of FIG. 1;

FIG. 5 is a schematic flow diagram illustrating altering privacy settings on an electronic network by the data management system of FIG. 1;

FIG. 6 is a schematic flow diagram illustrating data deletion on an electronic network by the data management system of FIG. 1;

FIG. 7 is a schematic flow diagram illustrating the transfer of data between an electronic network and an electronic device by the data management system of FIG. 1;

FIG. 8 is a schematic flow diagram illustrating the distribution of data to an electronic network by the data management system of FIG. 1; and

FIG. 9 is a schematic flow diagram illustrating the distribution of data to a program application by the data management system of FIG. 1.

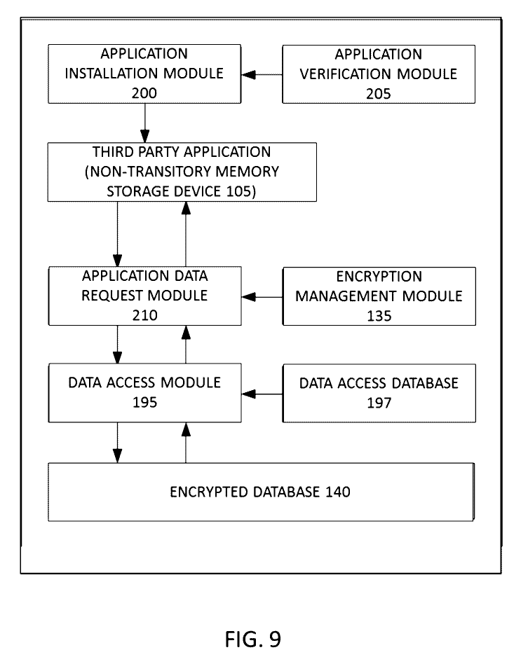

### DETAILED DESCRIPTION

The present invention generally relates to systems, methods, and associated program products for minimizing, retrieving, securing, and selectively distributing data associated with personal information corresponding to a user.

As described herein, the term electronic network can refer to a system for communication between multiple electronic devices, and can include various internet-based and computer-based platforms, for example, social media networks, cloud-based services, product purchase websites, and communication programs.

As described herein, the term electronic device can refer to a hardware device that is electronically coupleable to one or more electronic networks, and can include smartphones, laptops, and other portable or stationary computing devices.

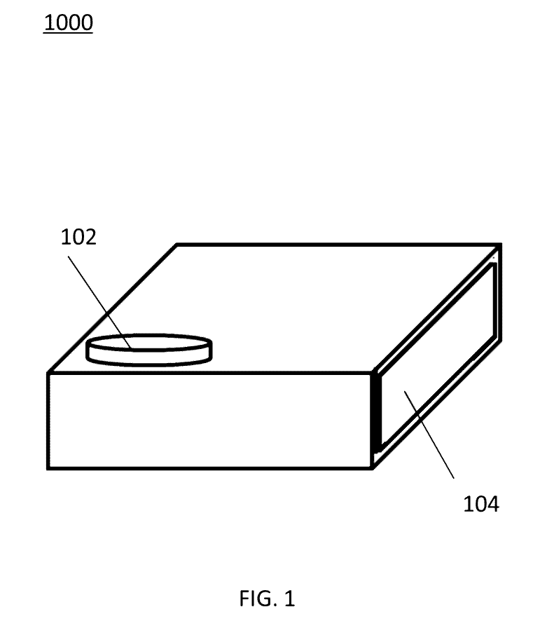

Referring to FIG. 1, a data management system according to an exemplary embodiment of the present invention is illustrated and generally designated 1000. Data management system 1000, as shown, can be a hardware device configured for interfacing and interoperating with one or more computer systems. Accordingly, data management system 1000 can include a hardware interface 102, such as a USB adapter, for insertion into and/or coupling with a compatible interface on a computing system. Hardware interface 102 can be housed within an interior portion of data management system 1000 prior to use and can be caused to swing out from or otherwise protrude from the data management system 1000 through the use of an actuator 104. While shown as a push button, actuator 104 can have a different configuration to cause mechanical and/or electronic activation of portions of data management system 1000, such as a thumbprint scanner, retinal scanner, or voice scanner. While illustrated as a standalone hardware device, data management system 1000 can be integrated into one or more computer systems as hardware elements and/or associated machine-readable instructions.

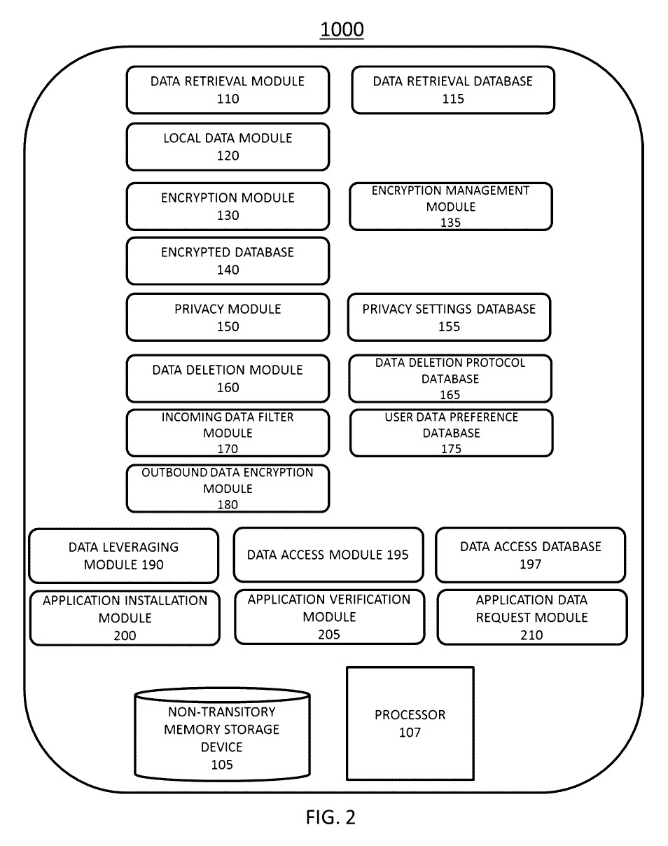

Referring additionally to FIG. 2, a schematic diagram of data management system 1000 is illustrated. Data management system 1000 includes a data retrieval module 110 and associated data retrieval database 115, a local data module 120, an encryption module 130 and associated encryption management module 135, an encrypted database 140, a privacy module 150 and associated privacy settings module 155, a data deletion module 160 and associated data deletion protocol module 165, an incoming data filter module 170 and associated user data preference database 175, an outbound data filter module 180, a data leveraging module 190, a data access module 195 and associated data access database 197, an application installation module 200, an application verification module 205, and an application data request module 210.

Data management system 1000 is configured to minimize, retrieve, store, secure, distribute, and/or otherwise manipulate electronic data associated with personal information that exists on one or more electronic networks and/or electronic devices.

Accordingly, data management system 1000 can include one or more modules dedicated toward performing tasks relating to data associated with personal information of a user occurring on the data management system 1000 and/or other electronic systems. Such modules can be computer hardware elements and/or associated elements of machine-readable instructions directed toward one or more actions with respect to data associated with personal information of a user. Electronic data and/or machine-readable instructions can be stored on one or more non-transitory memory storage devices 105 of the data management system 1000, and such data can be read by one or more processors 107 of the data management system 1000. It will be understood that data management system 1000 can be devoid of processors, and can instead use the processing capabilities of computer systems with which data management system 1000 is interfaced.

Data Retrieval

As described herein, data management system 1000 is configured to retrieve and electronic data associated with personal information corresponding to a user from one or more external sources. Such actions of data management system 1000 allow users to compile data from different electronic networks for use as an aggregated data set.

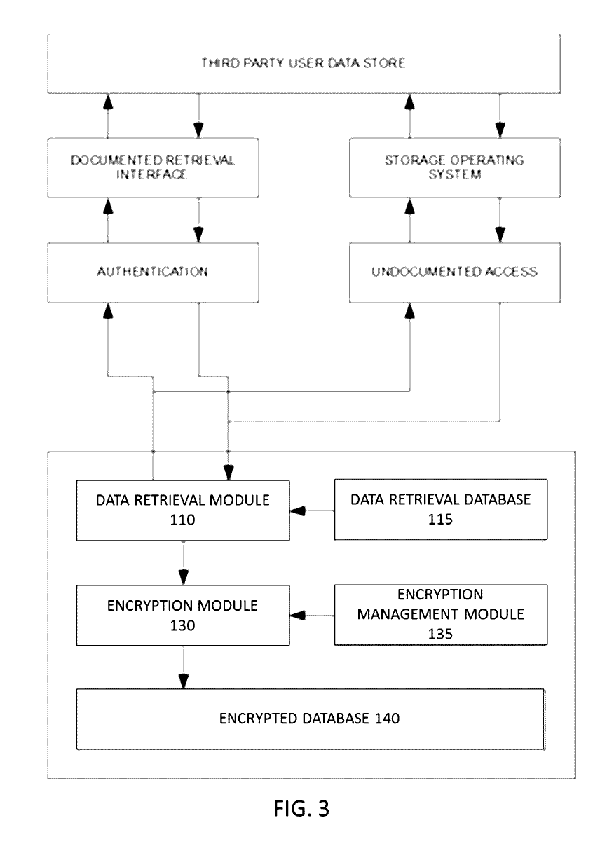

Still referring to FIG. 2, and referring additionally to FIG. 3, data management system 1000 includes a data retrieval module 110 configured to access and retrieve data associated with a user's personal information on one or more third-party electronic networks. Such actions by the data management system 1000 aggregate data associated with personal information corresponding to a user that is typically distributed across multiple electronic networks.

Data retrieval module 110 can be configured to determine a best method of data retrieval from a set of methods for data retrieval stored on an associated data retrieval database 115. In this regard, data retrieval module 110 applies an algorithm to determine a best method of data retrieval with respect to a given third-party electronic network.

Such methods can include authentication (e.g., login) to the third-party electronic network and accessing data through a documented retrieval interface of the third-party electronic network. Additionally or alternatively, data retrieval module 110 can employ one or more undocumented access methods for retrieving data from a normally-inaccessible portion of a third-party electronic network, e.g., an operating system associated with the third-party user data store. Such undocumented access methods can include, for example, through social engineering or other unconventional methods of data retrieval.

Following retrieval of data from the third-party electronic network, the data is stored available for encryption by encryption module 130 and storage in encrypted database 140, as described further below.

Data management system 1000 is also configured to retrieve data associated with personal information on one or more electronic devices to which data management system 1000 is interfaced.

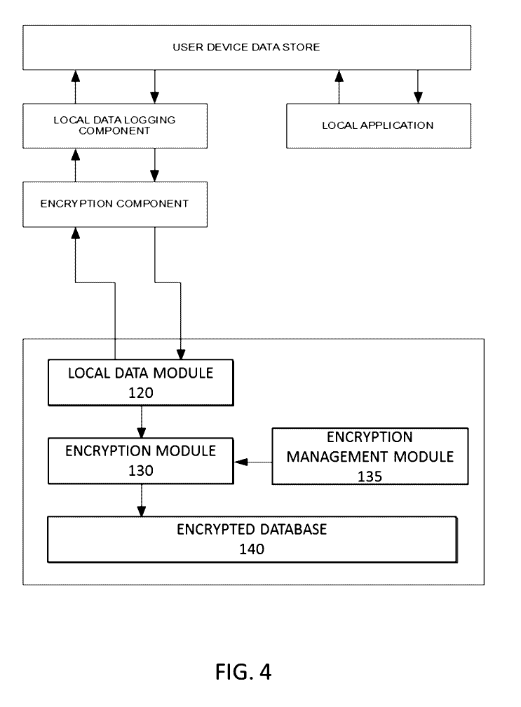

Still referring to FIG. 2, and referring additionally to FIG. 4, data management system 1000 includes a local data module 120 for retrieving data from electronic devices with which data management system 1000 can be interfaced. Local data module 120 can include machine-readable instructions, e.g., computer code, that is stored on one or more non-transitory memory storage devices of an electronic device and run on one or more processors of the electronic device. In this regard, local data module 120 can access data associated with personal information that is generated in the course of use of an electronic device, for example, by granting administrator-level access to operating system functions of the electronic device to data management system 1000.

Local data module 120 is configured to communicate with a local data logging component which is installed on a portion of the electronic device (e.g., one or more portions of computer-readable code). The local data logging component, as shown, may apply one or more encryption techniques to data being transmitted to the data management system 1000, e.g., transport layer security. Local data module 120 then passes the retrieved data to encryption module 130 for storage in the encrypted database 140, as described further herein.

Data Security

As described above, data management system 1000 is configured to secure, e.g., through encryption techniques, data associated with personal information corresponding to a user that is retrieved from third-party electronic networks and/or electronic devices. Such actions by data management system can protect data associated with personal information corresponding to a user from abuse, for example, hacking, data breaches, or other unauthorized accesses.

Still referring to FIG. 2, data management system 1000 includes an encryption module 130 for securing data associated with personal information that is input to data management system 1000. Encryption module 130 can be configured to apply one or more data security functions to data within data management system 1000. Encryption module 130 can be configured to determine a best method of data security from a set of encryption protocols stored on an associated encryption management module 135. Such data security methods can include various cryptographic algorithms known in the art, for example, employing the use of public and private keys for verification.

Referring again to FIGS. 3 and 4, encryption module 130 retrieves data from a third-party electronic network or an electronic device and transfers the encrypted data for storage in encrypted database 140, as described further herein.

Data stored in encrypted database 140 may be grouped by additional identifying data, e.g., metadata, so that data stored in encrypted database 140 can be mapped and/or searched for later retrieval, such as through an indexing system. As described further herein, access to data in encrypted database 140 can be restricted in such a way that only an aggregation of the data stored therein, and not the actual data itself, is transmitted from encrypted database 140 to other destinations. Accordingly, encryption module 130 is configured to apply one or more encryption techniques that result in the encryption and/or aggregation of data for storage in the encrypted database 140.

Data Privacy

As described herein, data management system 1000 is also configured to access one or more third-party electronic networks and restrict the future recording of electronic data associated with personal information corresponding to a user and/or remove already-recorded data. Such actions by data management system can minimize a user's electronic “footprint”, e.g., data trail, generated through typical use of electronic networks.

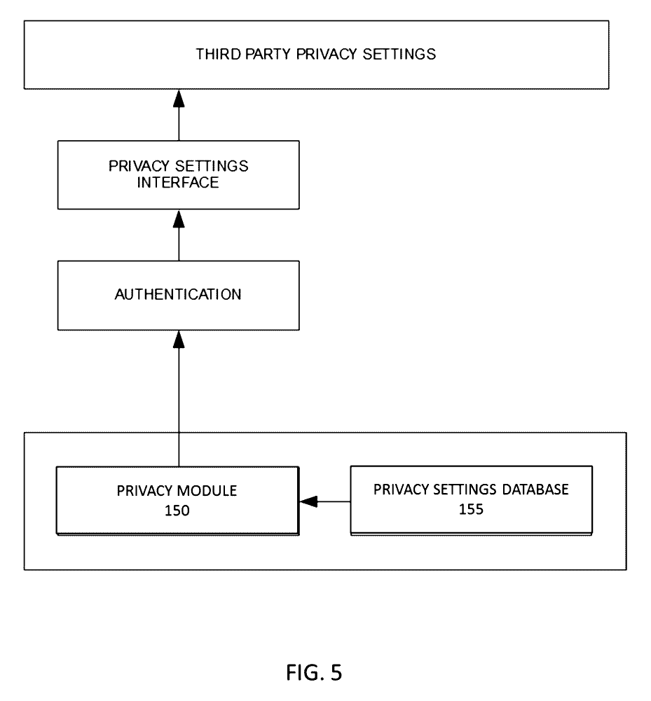

Still referring to FIG. 2, and referring additionally to FIG. 5, data management system 1000 includes a privacy module 150 for accessing one or more third-party electronic networks. Privacy module 150 employs one or more methods of accessing and altering settings associated with data privacy on a user account on one or more third-party electronic networks (for example, social media networks, web browsers, website accounts, etc.). Such an action can be taken through a privacy settings interface of a third-party electronic network, which can optionally require authentication (e.g., login) by the data management system 1000. The one or more methods of accessing and altering such settings may be selected from one or more available methods stored on an associated privacy settings database 155. For example, privacy module 150 can select a data worm specifically configured to access a user's Facebook account and set all available privacy settings (e.g., photo sharing, visibility of shared content to others, etc.) to their respective maximum settings.

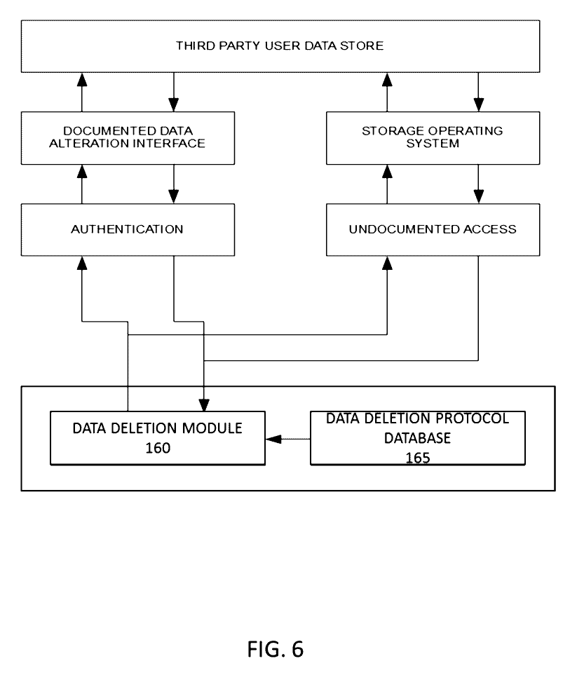

Still referring to FIG. 2, and referring additionally to FIG. 6, data management system 1000 also includes a data deletion module 160 for accessing one or more third-party electronic networks and eliminating electronic data associated with personal information stored on the third-party electronic networks. Accordingly, data deletion module 160 employs one or more methods of accessing and deleting data associated with a user's account on one or more third-party electronic networks. The one or more methods of accessing and altering such settings may be selected from one or more available methods stored on an associated data deletion protocol database 165.

Such methods can include authentication (e.g., login) to the third-party electronic network and accessing data for deletion through a documented retrieval interface of the third-party electronic network. Additionally or alternatively, data deletion module 160 can employ one or more undocumented access methods for accessing and deleting data from a normally-inaccessible portion of a third-party electronic network, e.g., an operating system associated with the third-party user data store. Such undocumented access methods can include, for example, methods involving the use of social engineering or other unconventional methods of data retrieval.

Data Transfer

As described above, data management system 1000 is also configured to securely handle the transmission of data occurring between a third-party electronic network and an electronic device. Such actions by the data management system 1000 can provide for the secure transfer of data between a user's electronic device and one or more electronic networks using the data management system 1000 as an intermediary.

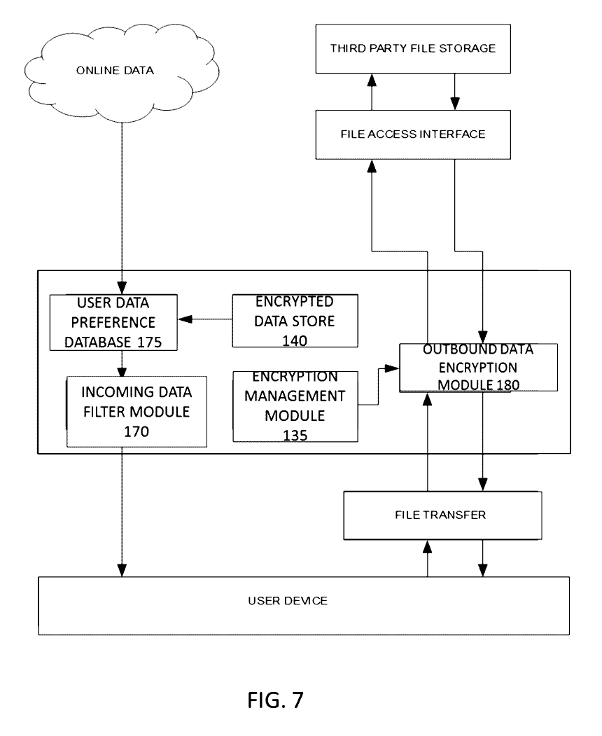

Still referring to FIG. 2, and referring additionally to FIG. 7, data management system 1000 includes an incoming data filter module 170 configured to control the content of data being transferred to an electronic device from a third-party electronic network, such as a cloud-based online service. Such filtering actions can include the removal of selected data from an incoming data stream, and/or the allowance of selected data to persist in an incoming data stream after a filtering determination has been made. In this regard, incoming data filter module 170 can include an associated user data preference database 175 that provides user preferences with respect to the content of incoming data. Such preferences can be manually configured by a user or can be derived from another portion of data management system 1000, for example, encrypted database 140.

Data management system 1000 also includes an outbound data encryption module 180 to apply one or more data security functions to data being transmitted from a user's electronic device to a third-party electronic network. Outbound data encryption module 180 can be configured to determine a best method of data encryption from a set of encryption protocols stored on the associated encryption management module 135 as described above. It will be understood that outbound data encryption module 180 can include a separate associated management module for storing a set of encryption protocols. Data encrypted by the outbound data encryption module 180 can be electronically communicated to a file access interface and storage medium on a third-party electronic network, as shown.

Data management system 1000 can also be configured to provide verification of the authenticity of data transmitted to third-party electronic networks, for example, through the issuance of cryptographic keys.

Data Leveraging

As described herein, data management system 1000 is configured to selectively distribute data associated with personal information corresponding to a user to one or more third-party electronic networks and/or electronic devices in a partially-anonymized, e.g., compiled and/or aggregated form. Such actions by data management system 1000 can allow a user to distribute subsets of data associated with his or her personal information to selected recipients and for selected purposes. For example, a user may wish to communicate overview, “high-level” data such as yes or no responses, without providing additional detailed information in response to various requests for data.

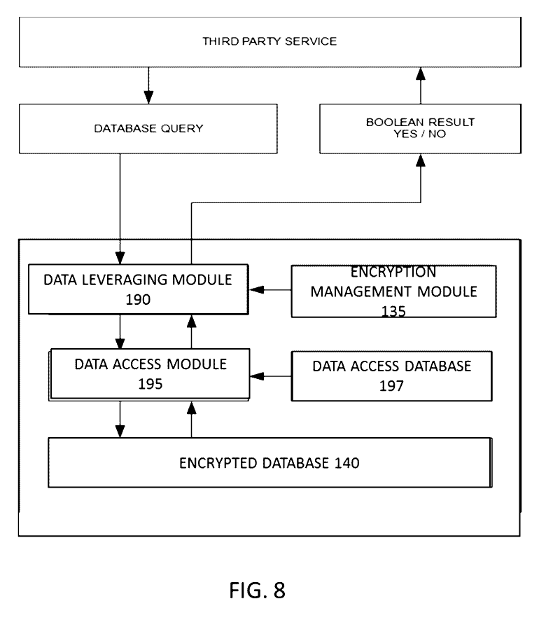

Still referring to FIG. 2, and referring additionally to FIG. 8, data management system 1000 includes a data leveraging module 190 for processing a request for data from one or more third-party electronic networks and handling the communication of data from data management system 1000 to the one or more third-party electronic networks.

Data leveraging module 190 is configured to receive a data request from one or more third-party electronic networks, and in particular, a structured description of the nature of the data being requested. The data leveraging module 190 transmits the request to a data access module 195 which accesses a data access database 197 for verification of the request.

Upon verification of the request, data leveraging module 190 instructs data access module 195 to retrieve relevant data from encrypted database 140 in the form of a partially-anonymized, e.g., compiled and/or aggregated, response. Such a response may be in the form of a Boolean-type TRUE or FALSE, e.g., YES or NO, value in response to a data request. For example, a user may wish to indicate “yes” in response to a query as to whether he or she is a repeat customer of a business, but may not wish to provide additional detailed information such as frequency or content of past purchases. In this regard, a user can engage in bargaining practices, for example, to become eligible for discounted goods or services, without sacrificing detailed information that he or she may not wish to share.

As described herein, data management system 1000 is configured to provide at least partially-anonymized data in response to specific types of questions, e.g., Boolean-type TRUE or FALSE or YES or NO questions. Accordingly, data leveraging module 190 can be configured to filter certain types of data requests, e.g., requests for specific data that cannot be responded to with a Boolean-type answer. Data leveraging module 190 can also be configured to limit a number of data requests from a particular third-party electronic network or other requestor, e.g., so that specific data cannot be derived from the responses to a flood of Boolean-type data requests.

Data leveraging module 190 then transmits the at least partially-anonymized data to the requesting third-party electronic network in response to the data request.

Such at least partially-anonymized data can be used by a user to receive commercial benefits (such as discounted offers for goods and services) and/or financial benefits (such as favorable credit ratings and loan determinations). The at least partially-anonymized data can also be used in direct transactions with third parties at the direction of the user, for example, the user could distribute the at least partially-anonymized data in exchange for a discount voucher for goods or services.

Further, such at least partially-anonymized data can be provided to various third party services for use in filtering determinations with regard to advertising content (for example, a web browser could use the at least partially-anonymized data to screen advertisements that do not offer a benefit to a user). In one example, a web browser or other third party service could set a threshold rating of a commercial benefit (which could be calculated based on a difference in value between a discounted price and the undiscounted price for a good or service) to determine whether advertising content should be transmitted to a user.

As data management system 1000 is configured to provide data to third parties, it will be understood that one or more mechanisms may be incorporated into the operation of data management system 1000 to ensure that portions thereof have not been tampered with. As an example, a secure boot mechanism may be incorporated into data management system 1000 an run before data management operations begin. Such mechanisms are known in the art, and described in, for example, U.S. Pat. Nos. 8,838,952; 5,937,063; 8,775,784; 8,201,204; and 8,589,302.

Application Hosting

Data management system 1000 can be configured to host one or more third-party applications on portions thereof. For example, one or more third-party applications (e.g., computer programs) can be stored on the one or more non-transitory memory storage devices 105 and implemented by the one or more processors 107. Such actions by the data management system 1000 can provide a user with a controllable, secured, and electronically isolatable environment within which one or more third-party applications can be run and provided with access to anonymized data.

Accordingly, data management system 1000 can include an application installation module 200 configured to install one or more third-party applications on data management system 1000. An application verification module 205 is associated with application module 200 and verifies the authenticity of third-party applications installed on data management system 1000, for example, by checking a digital source certificate associated with a third-party application and/or by subjecting third-party applications to one or more user-defined or device-defined criteria.

Data management system 1000 can also include an application data request module 210 for handling a request for data from the one or more third-party applications on data management system 1000. Third-party applications installed on data management system 1000 can access data from encrypted data store as described above, e.g., by initiating a request to data access module 195, so that third-party applications installed on data management device can retrieve at least partially-anonymized data from encrypted database 140. While the above-described actions of data access module 195 and associated data access database 197 in verifying the authenticity of source of the data request, it will be understood that the actions of application verification module 205 may obviate the need for a digital verification certificate to be issued along with a data request.

Accordingly, a request for data from one or more third-party applications on data management system 1000 can be satisfied by providing anonymized data from the encrypted database 140.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. A data management system, comprising:
a hardware interface for electronic coupling with one or more computer systems;
a data retrieval module configured to access and retrieve data on a third-party electronic network;
an encryption module that applies encryption to the data such that an at least partially-anonymized subset of the data is available in response to a request for data; and
an encrypted database for storing the data and the at least partially-anonymized subset of the data.

2. The data management system of claim 1, wherein the data is associated with personal information corresponding to a user.

3. The data management system of claim 1, further comprising a local data module configured to access data on an electronic device.

4. The data management system of claim 1, further comprising a privacy module configured to access privacy settings on the third-party electronic network.

5. The data management system of claim 1, wherein the privacy module is configured to change privacy settings on the third-party electronic network.

6. The data management system of claim 1, further comprising a data deletion module configured to access data on an electronic device.

7. The data management system of claim 6, wherein the data deletion module is configured to delete data on the electronic device.

8. The data management system of claim 1, further comprising a data filter module configured to filter a stream of data transmitted through the data management system.

9. The data management system of claim 1, further comprising an outbound data encryption module configured to encrypt a set of data transmitted from the data management system to the third-party electronic network.

10. The data management system of claim 1, further comprising a data leveraging module configured to receive a request for data from the third-party electronic network.

11. The data management system of claim 10, further comprising a data access module configured to retrieve the at least partially-anonymized subset of the data from the encrypted database in response to the request for data.

12. The data management system of claim 10, wherein the request for data is a Boolean-type request.

13. The data management system of claim 11, wherein the data leveraging module is configured to transmit the at least partially-anonymized subset of the data in response to the request for data.

14. The data management system of claim 1, wherein encryption applied to the data by the encryption module comprises at least one of aggregating and compiling the data.

15. A method, comprising:
(a) retrieving, by a data management system interfaced with a computer system, data from an electronic network;
(b) encrypting, by an encryption module of the data management system, the data retrieved from the electronic network;
(c) providing, by the encryption module of the data management system, an at least partially-anonymized subset of the data retrieved from the electronic network that is available separately from the data; and
(d) storing, by the data management system, the data and the at least partially-anonymized subset of the data on an encrypted database of the data management system.

16. The method of claim 15, wherein the data is associated with personal information corresponding to a user.

17. The method of claim 15, wherein the step of encrypting comprises aggregating the data.

18. A method, comprising:
(a) accessing, by a data management system interfaced with a computer system, an electronic network;
(b) determining, by a privacy module of the data management system, a method of accessing a privacy setting associated with the electronic network;
(c) accessing, by the privacy module of the data management system, the privacy setting associated with the electronic network; and
(d) altering, by the privacy module of the data management system, the privacy setting associated with the electronic network.

19. The method of claim 18, wherein the step of altering the privacy setting associated with the electronic network comprises transmitting a data worm to the electronic network.

20. The method of claim 18, wherein the step of determining a method of accessing a privacy setting associated with the electronic network comprises selecting a method from a privacy settings module associated with the privacy module.
